(19) United States
(12) Patent Application Publication
(10) Pub. No.: US 2007/0127410 A1
(43) Pub. Date: Jun. 7, 2007

(54) QoS for AV transmission over wireless networks

(76) Inventors: Jianlin Guo, New Providence, NJ (US); Jinyun Zhang, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/295,320

(22) Filed: Dec. 6, 2005

(51) Int. Cl. H04Q 7/00

(52) U.S. Cl. 370/328

(57) ABSTRACT

A method manages dynamically bandwidth for transport streams in a wireless network. An available bandwidth is defined for the network. An instantaneous bandwidth required by transport streams transmitted according to a hybrid coordination function controlled channel access (HCCA) category and an enhanced distributed channel access (EDCA) category is determined. The available bandwidth is compared to the instantaneous bandwidth, and the bandwidth of low priority transport streams is adjusted dynamically if the instantaneous bandwidth is different than the available bandwidth.

### FIELD OF THE INVENTION

The invention relates generally to wireless local networks, and more particularly to the quality of service (QoS) for AV transmission over wireless networks.

### BACKGROUND OF THE INVENTION

Streaming data, particularly audio-visual (AV) data, in a wireless network of stations (STA), is difficult due to high bandwidth (bit rate), short latency, and low error rate requirements. Often, conventional streaming techniques are unable to deliver a quality AV stream to the stations.

The IEEE 802.11e standard defines a set of quality of service (QoS) enhancements for local area networks (LANs) known as a WiFi networks. The standard enables high-bandwidth, delay-sensitive applications, such as voice, video, and multimedia. The standard also defines various bandwidth requirements, e.g., in the range of 11-54 Mbps.

Channel access in such networks is coordinated according to a beacon signal that is broadcast periodically, e.g., ten times per second. The time period associated with the beacon signal is called a beacon interval. The beacon interval includes a contention period and a contention free period. During the contention period, any station can access the channel using some random access method. During the contention free period, stations access the channel only during transmit opportunities (TXOP) or “slots” allocated according to a strict schedule to guarantee interference free transmissions.

The IEEE 802.11 standard describes an enhanced distributed channel access (EDCA) category and a hybrid coordination function (HCF) controlled channel access (HCCA) category at a media access (MAC) layer to enhance the QoS for bit streams or “traffic flows.” EDCA is for contention based transfer, and HCCA is for contention free transfer. Stations can obtain the TXOPs using these channel mechanisms.

The IEEE 802.11 also provides four access categories (AC) mapped to corresponding priorities, in a high to low order: voice, video, best effort, and low. However, those priorities are inadequate in a wireless network where the available bit rate or bandwidth changes over time. For example, bandwidth can be reduced due to fading channel conditions and network overload. Network overload can occur when the network traffic is unmanaged, as can be the case during a ‘best effort’ transfer. In that case, the quality of selected streams is reduced to guarantee the quality of other AV streams.

FIG. 1 shows the traffic specification (TSPEC) 100 for a traffic flow in a IEEE 802.11 network. The TSPEC contains parameters that define characteristics and QoS expectations of the traffic flow. Mandatory parameters include the user assigned priority, mean data rate, nominal MAC service data unit (MSDU) size, and maximum service interval. The main purpose of the TSPEC is for resource allocation as described in greater detail below. Of particular interest are the following fields, mean data rate 101, nominal MSDU size 102, TSInfo Ack Policy 103, and Access Policy 104.

Table A shows the prior art priority to access category mapping.

TABLE A
PRIORITY TO ACCESS CATEGORY MAPPINGS

| | Access Category | Designation |
|---|---|---|
| Priority | (AC) | (Informative) |
| 1 | 0 | Best Effort |
| 2 | 0 | Best Effort |
| 0 | 0 | Best Effort |
| 3 | 1 | Video Probe |
| 4 | 2 | Video |
| 5 | 2 | Video |
| 6 | 3 | Voice |
| 7 | 3 | Voice |

The IEEE 802.11 standard is described further in IEEE 802.11 Std, “Wireless Medium Access Control (MAC) and Physical Layer (PHY) specifications,” 1999; IEEE Std. 802.11e-D8.0, “Draft Amendment to IEEE standard for Information Technology, Telecommunications and Information Exchange Between systems-LAN/MAN Specific Requirements-Part 11: Wireless Medium Access Control (MAC) and Physical Layer (PHY) specification”, February 2004; Y. Xiao, “IEEE 802.11e: QoS Provisioning at the MAC layer,” IEEE Wireless Communications, vol. 11, pp. 72-79, June 2004; Z. Kong, D. H. K Tsang, B. Bensaou, D. Gao, “Performance analysis of IEEE 802.11e contention-based channel access”, IEEE Selected Areas in Communications, vol. 22, pp. 2095-2106, December 2004; Y. Xiao, H. Li, “Evaluation of distributed admission control for the IEEE 802.11e EDCA,”IEEE Communications Magazine, vol. 42, pp. S20-S24, September 2004; and L. W. Lim, R. Malik, P. Y. Tan, C. Apichaichalermwongse, K. Ando, Y. Harada, “A QoS scheduler for IEEE 802.11e WLANs,” First IEEE Consumer Communications and Networking Conference, pp. 199-204. January 2004.

### SUMMARY OF THE INVENTION

One embodiment of the invention provides a QoS method for dynamically managing bandwidth to traffic streams in a wireless network of stations. The method operates at a logical link control (LLC) layer of an ISO data layer. The data layer also includes a media access (MAC) layer.

The QoS method guarantees required bandwidth for higher priority traffic streams whenever there is insufficient bandwidth for all traffic streams.

In order to manage bandwidth, the invention also provides a method to dynamically determine the amount of bandwidth being used and the amount of bandwidth available for use.

The QoS method dynamically monitors bandwidth conditions. If the bandwidth is sufficient, it takes no action. Once the bandwidth is over-demanding, the QoS method selects one or more low priority victim streams for which the bandwidth allocation will be reduced or no bandwidth is allocated. As soon as the bandwidth becomes available, the bandwidth allocation for the victim streams are increased immediately.

### BRIEF DESCRIPTION OF THE DRAWINGS

FIG. 1 is a block diagram of a prior art traffic specification for a traffic flow according to the a IEEE 802.11 standard;

FIG. 2 is a block diagram of a method for determining instant medium time according to an embodiment of the invention; and

FIGS. 3A-3D are flow diagrams of a dynamic bandwidth management method according to an embodiment of the invention.

### DETAILED DESCRIPTION OF THE DYNAMIC QoS METHOD

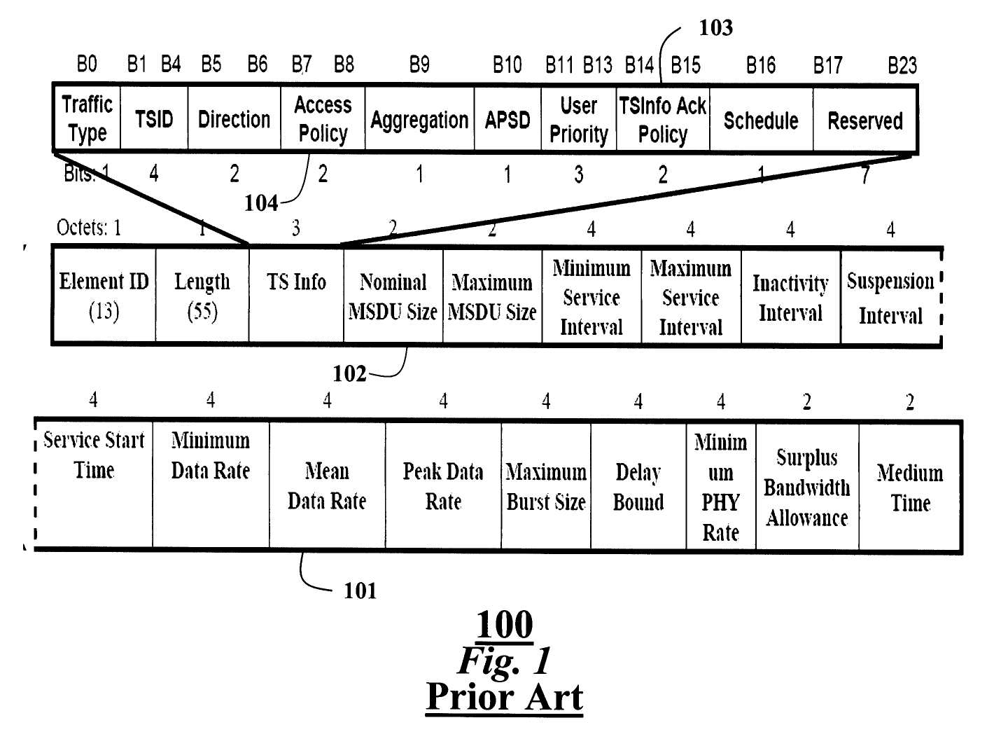

One embodiment of the invention provides a QoS method for managing bit rates (bandwidth) for bit streams in a wireless network of stations. As shown in FIG. 1, the method can use information as specified by the IEEE 802.11 traffic specification (TSPEC) 100, such as bit rate, packet size, ACK policy, and medium access category (EDCA or HCCA). The bit rates (bandwidth) defined can be within the range required by the standard, e.g., 11-54 Mbps.

The method can also apply instantaneous physical layer (PHY) bit rate allocation for bandwidth management in order to reflect dynamically changing channel conditions. The QoS method efficiently manages bandwidth by dynamically monitoring channel condition and traffic load.

To efficiently manage bandwidth, one problem to be solved is how to determine whether the available bandwidth is sufficient or not. If there is insufficient bandwidth, then certain bit streams may need to be degraded. If there is excess bandwidth, then some streams can be upgraded.

A method according to an embodiment of the invention solves this allocation problem by determining an “instant medium time.” For a given traffic stream (TS), the instant medium time is defined as the time needed, during a beacon interval, to transmit a desired amount of data according to an instantaneous PHY bit rate. The instant medium time essentially reflects the instantaneous bandwidth requirement of the TS.

Due to variability in the quality of a wireless link, the PHY bit rate can vary quickly. Therefore, the instant medium time required by the TS also varies dynamically. That is, the bandwidth required by the TS changes as channel conditions vary.

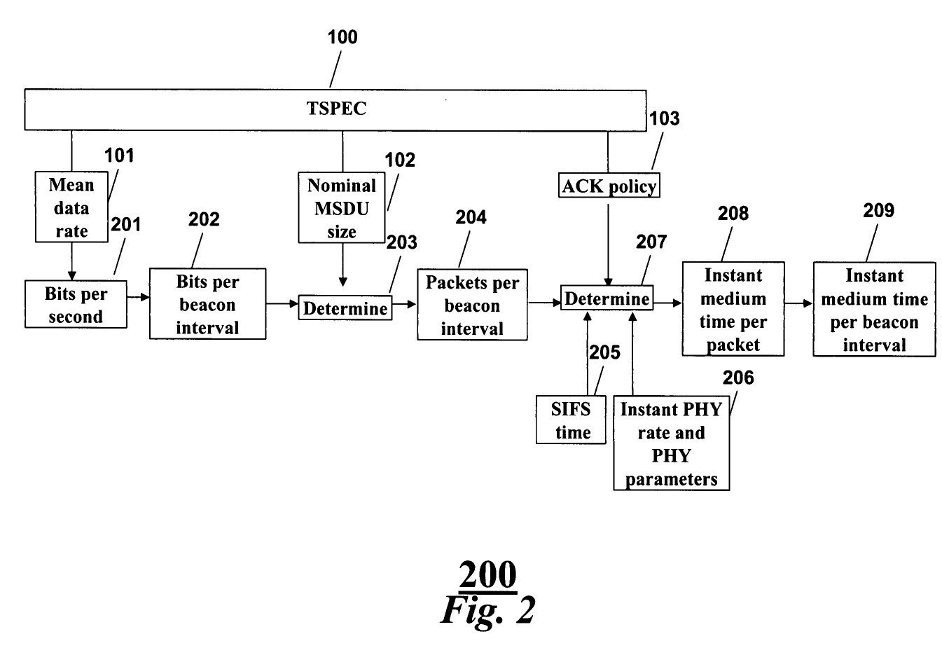

FIG. 2 shows a procedure 200 for determining instant media times for packets 208 and beacon intervals 209. In one embodiment, the network is designed according to the IEEE 802.11 standard.

This procedure is used by the QoS method to dynamically manage bandwidth. For each TS, the mean date rate 101 of the TS indicates the amount of the data to be transmitted per ‘instant’ of time, e.g., bits per second 201. Based on the amount of the data to be transmitted per second, the QoS method determines the amount of the data to be transmitted per beacon interval 202. Using this data amount and the TS nominal MSDU size 102, the QoS method determines 203 the number of packets to be transmitted per beacon interval 204. Based on the TS ACK policy 103, SIFS time 205, instant PHY rate and other PHY parameters 206, the QoS method determines 207 the instant medium time for each packet 208 and the instant medium time needed by a given TS within each beacon interval 209.

The second problem to be solved is how to select a ‘victim’ TS. A victim TS is a stream that is allocated a lower bit rate, or perhaps, completely stopped while the total available bandwidth in the channel is insufficient for all TSs. In addition, the de-allocation and re-allocation of bandwidth needs to be managed.

To solve this problem, the QoS method defines an additional priority for each TS. This new priority is different from the conventional priorities described in the IEEE 802.11 standard. There, all AV streams are assigned a small range of priorities, see Table A. This new priority is application dependent.

One way to define this new priority is to assign a TS bit rate with a higher bit rate TS to a higher priority, and assigning a lower priority to a lower bit rate TS. That is, the priorities are bandwidth requirement dependent. The QoS method uses this new priority to determine the TSs for which bandwidth should be guaranteed and the TSs for which bandwidth should be reduced in case of bandwidth shortage.

With the instant medium time and the new priority, the QoS method can dynamically manage bandwidth. The QoS method performs bandwidth management operations by dynamically monitoring and adjusting bandwidth allocation according to channel condition and traffic load.

The goal is to guarantee bandwidth for a high priority TS with efficient bandwidth usability.

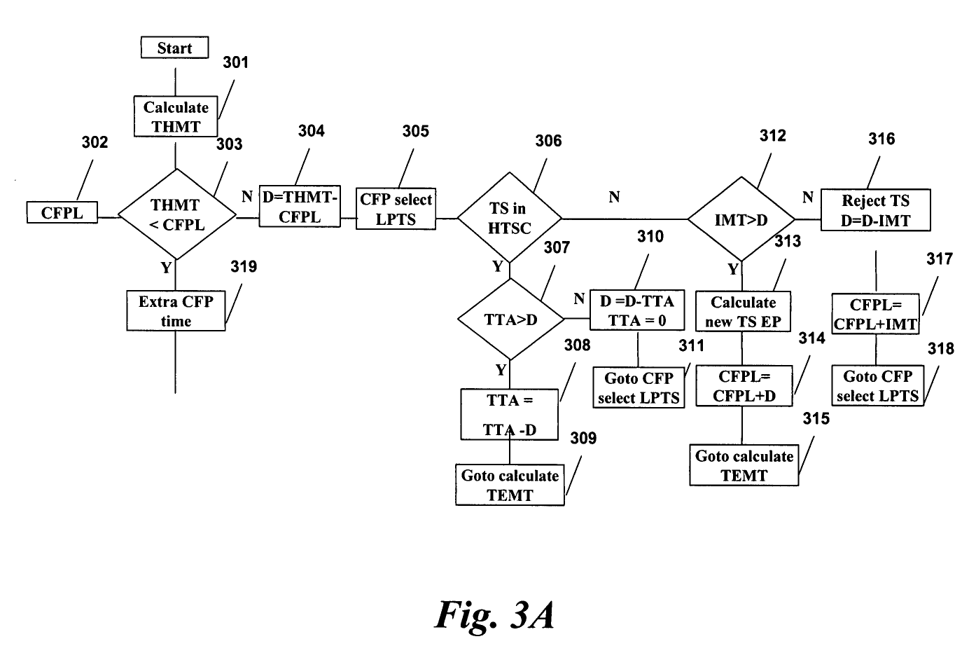

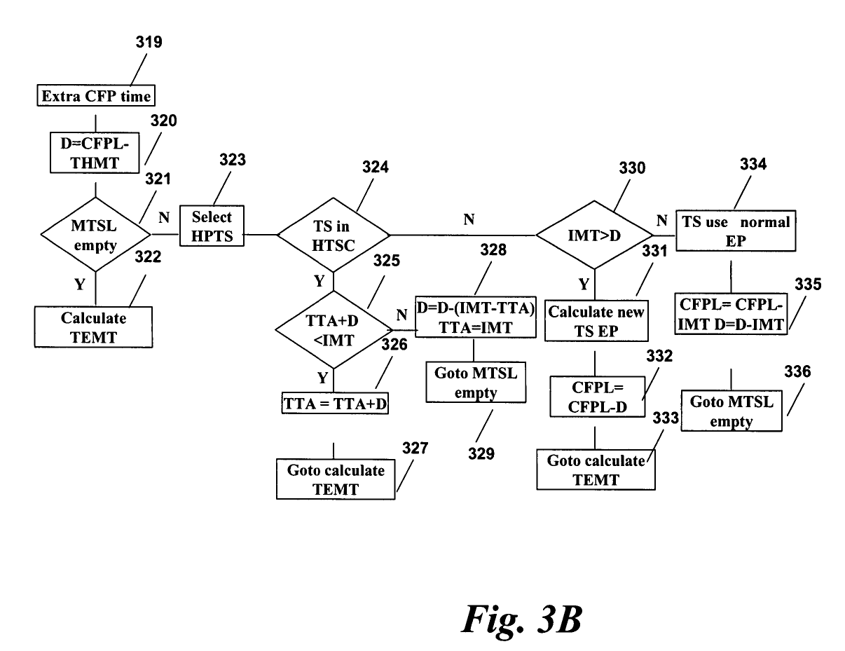

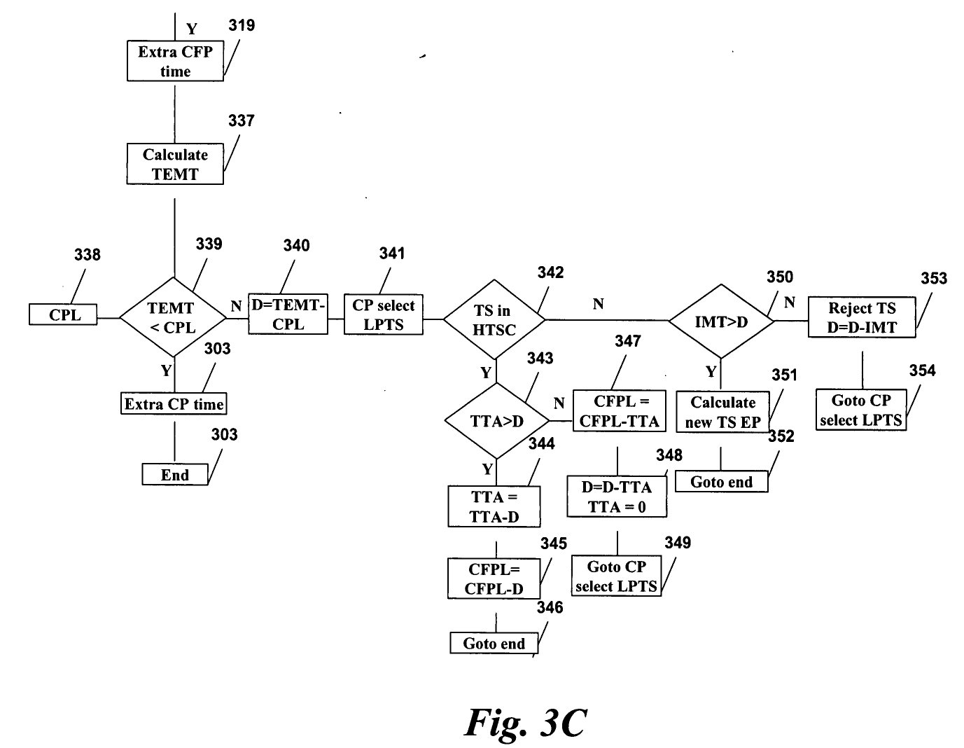

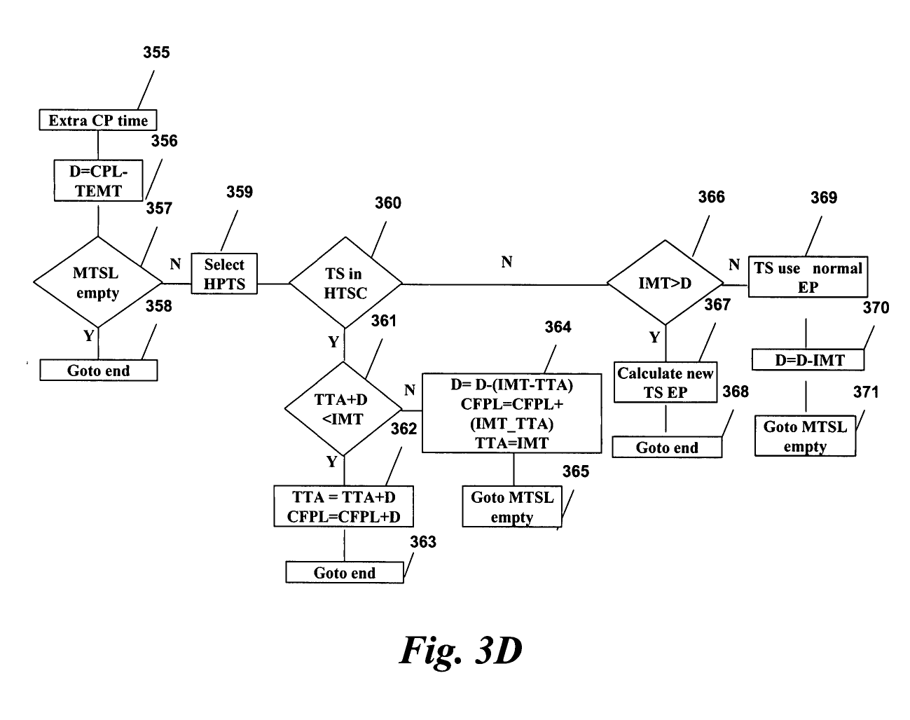

FIGS. 3A-3D show the dynamic bandwidth management performed by the QoS method according to an embodiment of the invention.

According to the IEEE 802.11 standard, time is partitioned into periodic intervals called beacon intervals. Each beacon interval is composed of a contention period (CP) and a contention free period (CFP) with the EDCA category used during the contention period, and the HCCA category used during the contention free period. Accordingly, the QoS method recognizes TSs according to the categories specified in the access policy 104, i.e., HCCA categories and EDCA categories.

As shown in FIG. 3A, the QoS method starts its operation by first determining the instant medium time (IMT) for each TS in an HCCA category. The QoS method then calculates the total instant medium time for all TSs in the HCCA category, denoted by THMT 301. The method compares the THMT with the contention free period length (CFPL) 302 to determine 303 if the bandwidth allocated for the HCCA category is insufficient or extra bandwidth is available. There are two cases.

Case 1: THMT is greater than CFPL. This means that the required bandwidth by the HCCA category is greater than the bandwidth allocated. That is, the bandwidth for the HCCA category is insufficient. Let D denote THMT minus CFPL 304. The QoS method selects 305 the lowest priority TS as a ‘victim’ which is marked as modified and inserted in a modified TS list (MTSL).

The QoS method determines 306 if the victim is in the HCCA category. If the victim is in the HCCA category and its total time allocated (TTA) is greater than D 307, the QoS method reduce its TTA by D 308. This actually solves the bandwidth shortage problem for the HCCA category. The QoS method goes to calculate the total instant medium time for all TSs in EDCA category 309, denoted by TEMT.

If the victim is in the HCCA category and its TTA is less than D, the QoS method rejects the victim for transmission 310, i.e., transmission is temporarily terminated. Because the bandwidth for the HCCA category is still insufficient, the QoS method continues selecting the lowest priority TS in transmission 311 until the bandwidth shortage problem for the HCCA category is resolved.

If the victim is in the EDCA category and its IMT is greater than D 312, the QoS method recalculates 313 the EDCA parameters for the victim, increases the length of the contention free period by D 314, and calculates TEMT 315 because the bandwidth shortage problem for HCCA category is resolved.

If the victim is in the EDCA category and its IMT is less than D, then the QoS method rejects the victim for transmission and updates D 316, increases the length of the contention free period by IMT 317, and selects the lowest priority TS 318 because bandwidth shortage problem for the HCCA category has not yet been solved. If the victim stream is being transmitted using the HCCA category, the QoS method polls the victim according to the new TTA. If victim is in the EDCA category, the QoS method informs the victim transmitter about the EDCA parameters change. When a transmitter receives such notification, the transmitter uses the new EDCA parameters immediately.

Case 2: As shown in FIG. 3B, the THMT is less than the CFPL. This indicates that the required bandwidth by the HCCA category TS is less than the bandwidth allocated. That is, extra contention free period time is available 319. The QoS method redistributes this extra time.

Let D denote CFPL minus THMT 320. The QoS method checks if MTSL is empty 321. If yes, the QoS method calculates TEMT 322. If not, the QoS method selects the highest priority TS in MTSL 323. The QoS method determines 324 if the selected TS is in the HCCA category. If the TS is in the HCCA category and its TTA plus D is less than its IMT 325, then the QoS method increases its TTA by D 326. The TS remains in MTSL because its bandwidth requirement has not been satisfied completely. Because there is no more extra contention free period time left, the QoS method calculates TEMT 327.

If the TS is in the HCCA category and its TTA plus D is greater than its IMT, the QoS method increases 328 its TTA to IMT and removes the TS from MTSL. Because extra contention free time has not been used fully, the QoS method checks MTSL 329.

If the TS is in the EDCA category and its IMT is greater than D 330, the QoS method recalculates the EDCA parameters for this TS 331, reduces CFPL by D 332 and calculates TEMT 333. The TS stays in MTSL.

If the TS is in EDCA category and its IMT is less than D, the QoS method lets the TS to be transmitted use the normal EDCA parameters 334, removes the TS from MTSL, reduces CFPL by IMT 335, and checks MTSL 336 because extra contention free period time is still left. The QoS method informs the TS transmitter about the EDCA parameters change.

As shown in FIG. 3C, after adjusting bandwidth allocation for HCCA category, the QoS method performs similar bandwidth management operations for the EDCA category. The QoS method calculates TEMT 337 and the contention period length (CPL) 338. Then, the method compares TEMT with CPL 339 to determine if the bandwidth allocated to the EDCA category is sufficient or not, and performs bandwidth adjustment if necessary. There are also two cases to be considered.

Case 1: TEMT is greater than CPL. This means that the required bandwidth by the EDCA category is greater than the bandwidth allocated. That is, the bandwidth for the EDCA category is insufficient.

Let D denote TEMT minus CPL 340. The QoS method selects the lowest priority TS in transmission as a victim 341 which is marked as modified and added into MTSL. The QoS method determines if the victim is in the HCCA category 342.

If the victim is in the HCCA category and its TTA is greater than D 343, the QoS method reduces its TTA by D 344 and reduces the CFPL by D accordingly 345. This provides the EDCA category with enough bandwidth, and the QoS method goes to end 346.

If the victim is in HCCA category and its TTA is less than D, the QoS method reduces CFPL by TTA 347, updates D and rejects the victim for transmission 348. Because bandwidth for the EDCA category is still in shortage, the QoS method selects the lowest priority TS in transmission again 349.

If the victim is in the EDCA category and its IMT is greater than D 350, then the QoS method recalculates the EDCA parameters for the victim 351 and goes to end 352.

If the victim is in the EDCA category and its IMT is less than D, then the QoS method rejects the victim for transmission 353 and selects the lowest priority TS in transmission again 354.

Case 2: TEMT is less than CPL. This indicates extra contention period time is available 355. The QoS method redistributes the extra time as shown in FIG. 3D. Let D denote CPL minus TEMT 356. The QoS method checks if MTSL is empty 357. If yes, no bandwidth adjustment is needed and the QoS method goes to end 358.

If not, the QoS method selects the highest priority TS in MTSL 359. The QoS method determines if the selected TS is in the HCCA category 360. If the TS is in HCCA category and its TTA plus D is less than its IMT 361, then the QoS method increases its TTA and CFPL by D 362, and goes to end 363.

If the TS is in the HCCA category and its TTA plus D is greater than its IMT, then the QoS method increases its TTA to IMT and increases CFPL accordingly 364. The TS is removed from MTSL. Because extra contention period time has not been used fully, the QoS method checks MTSL again 365.

If the TS is in the EDCA category and its IMT is greater than D 366, the QoS method recalculates the EDCA parameters for this TS 367 and goes toend 368.

However, the TS still stays in MTSL. If the TS is in the EDCA category and its IMT is less than D, the QoS method lets the TS to be transmitted use its normal EDCA parameters 369, removes the TS from MTSL, updates D 370 and checks MTSL again 371 because extra contention period time is still left.

Effect of Invention

QoS control is important, especially for wireless AV networks. The QoS method according to the embodiments of the invention operates at the LLC layer above the MAC layer. The QoS method provides an efficient mechanism for managing bandwidth if bandwidth is insufficient.

With the QoS method, the bandwidth for higher priority AV streams is guaranteed, and only lower priority AV streams are affected during bandwidth shortage.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for managing dynamically bandwidth for transport streams in a wireless network, comprising the steps of:
defining an available bandwidth in a wireless network;
determining an instantaneous bandwidth required by transport streams transmitted according to a hybrid coordination function controlled channel access (HCCA) category and an enhanced distributed channel access (EDCA) category;
comparing the available bandwidth to the instantaneous bandwidth; and
adjusting dynamically bandwidth of low priority transport streams if the instantaneous bandwidth is different than the available bandwidth.

2. The method of claim 1, in which the transport streams carry audio-visual data.

3. The method of claim 1, in which the wireless network operates according to the IEEE 802.11 standard.

4. The method of claim 3, in which the defining, determining, comparing and adjusting steps are performed at a logical link control layer of the network.

5. The method of claim 1, in which the instantaneous bandwidth is related to an amount of data to be transmitted by each transport stream per beacon interval.

6. The method of claim 1, in which priorities of the transport streams are application dependant.

7. The method of claim 1, in which priorities of the transport streams are assigned according to a bandwidth requirement of the transport streams.

8. The method of claim 1, in which the EDCA category is used during a contention period, and the HCCA category is used during a contention free period.

9. The method of claim 1, in which the instantaneous bandwidth requirements are determined for the HCCA category and then for the EDCA category.

10. The method of claim 1, in which the adjusting is performed first for transport streams in the HCCA category and then in the EDCA category.

11. The method of claim 1, in which transmissions in the network are coordinated according to beacon intervals, and each beacon interval includes a contention period and a contention free period, and the adjusting increases a length of the contention free period when the instantaneous bandwidth is greater than the available bandwidth.

12. The method of claim 1, in which transmissions in the network are coordinated according to beacon intervals, and each beacon interval includes a contention period and a contention free period, and each contention free period includes transmit opportunities for each transport stream, and the adjusting decreases a length of the transmit opportunities of the lower priority transport streams when the instantaneous bandwidth is greater than the available bandwidth.

13. The method of claim 1, in which transmissions in the network are coordinated according to beacon intervals, and each beacon interval includes a contention period and a contention free period, and the adjusting decreases a length of the contention free period when the instantaneous bandwidth is less than the available bandwidth.

14. The method of claim 1, in which transmissions in the network are coordinated according to beacon intervals, and each beacon interval includes a contention period and a contention free period, and each contention free period includes transmit opportunities for each transport stream, and the adjusting increases a length of the transmit opportunities of the lower priority transport streams when the instantaneous bandwidth is less than the available bandwidth.

15. The method of claim 1, in which the adjusting reduces the bandwidth of low priority transport streams if the instantaneous bandwidth is greater than the available bandwidth.

16. The method of claim 1, in which the adjusting increases the bandwidth of low priority transport streams if the instantaneous bandwidth is less than the available bandwidth.
